(19) United States
(12) Patent Application Publication
(10) Pub. No.: US 2003/0139273 A1
(43) Pub. Date: Jul. 24, 2003

(54) Method of reducing stresses in the folding material

(76) Inventors: Mugeni Nuamu, Lund (SE); Jorgen Bengtsson, Lund (SE)

Correspondence Address: BURNS DOANE SWECKER & MATHIS L L P, POST OFFICE BOX 1404, ALEXANDRIA, VA, 22313-1404, US

(21) Appl. No.: 10/258,970

(22) PCT Filed: Jun. 20, 2001
(86) PCT No.: PCT/SE01/01425

(30) Foreign Application Priority Data
Jun. 28, 2000 (SE) 0002430.7

(51) Int. Cl. B31B 49/00

(52) U.S. Cl. 493/408

(57) ABSTRACT

Packaging containers of single-use disposable type which are manufactured from flexible paper/plastic laminate normally display sealing fins (3) which extend over one or more of the walls (2) of the packaging container (1). In parallelepipedic packaging containers, triangular corner flaps (4) moreover occur over which extend the sealing fins (3). The corner flaps are folded down and secured on the final formation of the packaging container against its side wall. This however entails that the material with many times thickness must be double-folded, which entails deformations and stretching which damages the packaging material so that this no longer remains completely liquid-tight and gas-tight. According to the invention, the above-outlined drawbacks may be obviated in that the fibre layer included in the material is heated to a temperature of between 80 and 250° C. in the fold region, whereby the material softens so that the downward folding of the corner flaps together with subjacent parts of the sealing fin (3) may take place without the material being damaged. The liquid-tightness and gas-tightness of the finished packaging container will hereby be considerably improved, which is crucially important in the packaging of, for example, liquid foods.

### TECHNICAL FIELD

The present invention relates to a method of reducing material stresses in the double-folding of laminated paper/plastic material.

### BACKGROUND ART

A known and commonly occurring packaging container for packing, int. al. milk is manufactured from a flexible, web-shaped laminate which comprises a central core or carrier layer of paper which is coated on either side with thin layers of liquid-tight, thermosealable plastic material, e.g. polyethylene. The laminate is supplied to a filling machine in reel form and is reformed while being unwound from the reel progressively into tube form, while, at the same time as its longitudinal edges are sealed in liquid-tight fashion to one another, the tube is fed substantially vertically downwards through the filling machine. The tube is continuously supplied with contents via a filler pipe which extends down into the tube at its upper end. Thereafter, repeated transverse sealing of the tube takes place in that the tube is compressed at evenly spaced intervals with the aid of heated sealing jaws, whereby the thermosealable plastic layer located on the inside of the tube unites the sides of the tube in liquid-tight, transverse seals. There will hereby be realised band-shaped, continuous and substantially cushion-shaped packaging containers which are separated from one another by means of incisions in the above-mentioned sealing zones, whereafter additional forming processing of the filled, cushion-shaped containers gives them a final, substantially parallelepipedic configuration. In this final forming processing, four double-walled corner flaps occur which are formed by material which, for geometric reasons, cannot be utilised in the forming of the parallelepipedic container body proper. In order not to be in the way or distort the regular, parallelepipedic configuration, these flat-pressed corner flaps are folded in towards and sealed to adjacent packaging container surfaces. The packaging container is thereby finished.

As will have been apparent from the foregoing description, cushion-shaped packaging containers will be created on the transverse sealing and severing of the filled material tube, the containers displaying sealing fins at their upper and lower ends. After the reforming of the cushion-shaped containers into parallelepipedic configuration, these sealing fins will extend substantially centrally over the upper and lower end walls of the packaging container, and also over corner flaps adjacent these end walls. Thus, the sealing fin extends transversely over the end wall of the packaging container between the two free corners of the corner flaps connected to the end wall. In connection with the forming of the parallelepipedic packaging container, the sealing fins are folded down so that they abut against that material surface with which they are connected. As was mentioned earlier, the flat-pressed corner flaps are folded in and connected adjacent container walls. Both of the corner flaps located at the lower end of the packaging container are normally folded in towards the bottom end of the packaging container, which, however, is impeded by the sealing fin extending over both the bottom end and both of the corner flaps. Thus, on inward folding of a corner flap into abutment against the bottom end of the packaging container, not only both of the material layers which form the corner flap proper but also the sealing fin formed from two material layers must be folded over through 180°, which entails that the material layers which, after the folding operation, are located on the “outside” of the fold (i.e. the material layers located outside the incipient neutral plane), will be subjected to extremely powerful tensile stresses with consequential stretching and the risk of crack formation. These tensile stresses can be so great that the layers of thermoplastic included in the laminate run the risk of cracking, with the result that leakage occurs. When the laminate, as is often the case, also includes layers of aluminium foil (Alifoil), the risk of crack formation further increases, since the aluminium foil displays considerably poorer stretch properties than the thermoplastic material.

In order to obviate the above-outlined drawbacks, attempts have hitherto been made, in the manufacture of the laminate, to select material types with as favourable modulus of elasticity as possible, which has given relatively favourable results as regards the included thermoplastic layers, but not entirely solved the problem inherent in layers of, for example, aluminium which may possibly be included in the laminate. Attempts have also been made, in connection with the manufacture of the laminate, to process the intended fold regions in various ways, e.g. by reducing thickness or wholly removing parts of the fibre layer in the fold region in order hereby to reduce the overall thickness of the laminate in that critical region so that the tensile stresses in connection with the folding operation are reduced (Cf. European Patent No. 374).

Another, earlier attempt to reduce or obviate the above-mentioned drawbacks is described in Swedish Patent Specification No. 424.177. According to this solution, the material in the critical fold region is softened in that a plurality of fold- or crease lines are, on material manufacture, placed in a specific pattern within the critical fold region. In such instance, the laminate and, in particular its fibre layer, will be softened or broken up to such an extent that the folding can take place without the included laminate layers being subjected to such tensile stresses that crack formation occurs. Swedish Patent Specification No. 432.918 also describes a similar solution to the problem.

However, all prior art methods of obviating the problem under consideration here relate to measures that are adopted in connection with the manufacture of the packaging laminate. Since later experiments have shown that while the fundamental cause of the crack formation which occurs is the difficulty in double-folding a relatively thick packaging laminate consisting of a plurality of layers, the risk of crack formation will also be greatly affected by the condition of the laminate at that instant when it is reformed into individual packaging containers. Thus, for example those conditions under which the ready-manufactured packaging laminate has been stored and handled from the moment of manufacture to the moment it is placed in a filling machine for conversion into packaging containers is of crucial importance for the final result. Such parameters as varying raw materials (in particular varying raw materials for the fibre layer included) as well as the bonding between the different material layers included in the laminate are also of major importance at that instant the material is reformed into packaging containers. Since many of these factors are affected by, for example, storage time and storage conditions (humidity, temperature, etc.), those methods that are implemented, in connection with the manufacture of the material, to reduce the risk of crack formation will give extremely varying results on the day when the material—perhaps after months of storage—is to be reformed into packaging containers.

Hence, it has hitherto not been possible to find any method or technique which dependably guarantees that a previously manufactured packaging laminate can be reformed into the desired type of packaging container without there being the risk of crack formation at the most critical fold regions in the bottom portion of the packaging container.

There is thus a need within the art to realise a method which makes it possible, in a reliable manner, to reduce the material stresses on double-folding of laminated paper/plastic material to such an extent that harmful crack formation is certain not to occur on double-folding of the material.

### OBJECTS OF THE INVENTION

One object of the present invention is thus to realise a method of reducing material stresses on double-folding of laminated paper/plastic to such an extent that the material, in connection with its reforming into packaging containers, may be subjected to double-folding without the risk of harmful crack formation occurring.

A further object of the present invention is to realise a method of reducing material stresses on double-folding of laminated paper/plastic material, the method making it possible, on conversion of a known type of packaging container from cushion-shape into substantially parallelepipedic configuration, to realise inward folding of corner flaps and sealing fins extending over the corner flaps (i.e. two 180° folds along mutually intersecting or meeting fold lines) without any risk whatever of crack formation in the material layers of the packaging laminate occurring.

Yet a further object of the present invention is to realise a method of reducing material stresses on double-folding of laminated paper/plastic material, which may be reduced into practice in connection with the relevant folding cycle regardless of earlier processing and handling of the packaging laminate.

Still a further object of the present invention is finally to realise a method of reducing material stresses in double-folding of laminated paper/plastic material which is simple and economical to put into effect, and also well adapted to prior art methods and apparatuses for manufacturing parallelepipedic packaging containers.

### SOLUTION

The above and other objects have been attained according to the present invention in that a method of the type disclosed by way of introduction has been given the characterising features as set forth in the appended main Claim.

Preferred embodiments of the method according to the present invention have further been given the characterising features as set forth in the appended subclaims.

### BRIEF DESCRIPTION OF THE ACCOMPANYING DRAWINGS

One preferred embodiment of the method according to the present invention will now be described in greater detail hereinbelow, with particular reference to the accompanying, schematic Drawings. In the accompanying Drawings:

FIG. 1 is a perspective view of a packaging container of known type seen from beneath;

FIG. 2 shows a part of the bottom surface of the packaging container of FIG. 1 prior to the inward folding of a corner flap;

FIG. 3 shows the part of the packaging container illustrated in FIG. 2 after the inward folding of a corner flap; and

FIG. 4 is a section taken through a part of a laminated packaging material of the type which is employed for manufacturing packaging containers according to FIG. 1.

### DESCRIPTION OF PREFERRED EMBODIMENT

The method according to the present invention will now be described as applied to a packaging container of substantially parallelepipedic configuration, e.g. a packaging container of the type which is described in Swedish Patent Specification No. 406.177, but the present invention is naturally applicable to any type of packaging container whatever which displays the characterising features as mentioned by way of introduction.

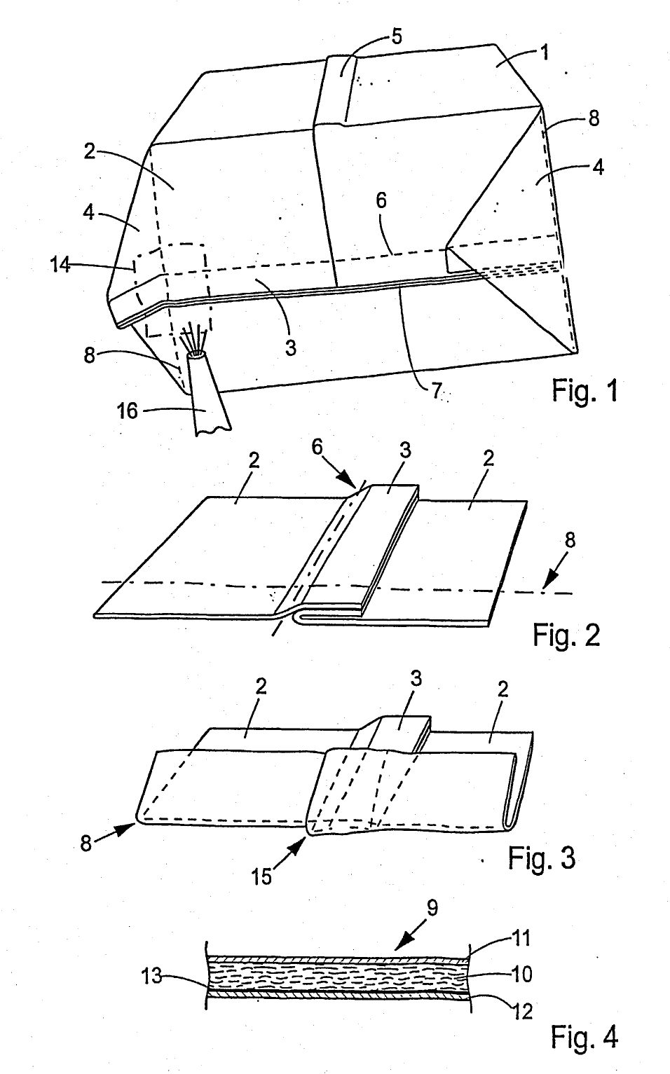

The known packaging container illustrated in FIG. 1 is of parallelepipedic type and comprises four substantially rectangular side walls 1 (of which only one is visible in the Figure), as well as two similarly substantially rectangular end walls 2 (of which only the one, viz. the bottom wall, is visible in the Figure). The packaging container is manufactured from a flexible, relatively configurationally rigid laminate material (which will be described in greater detail below with reference to FIG. 4) which has been formed into a tube which, by flat-pressing and transverse sealing at uniform spacing, has been closed in transverse, narrow zones. After similarly transverse severing in the above-mentioned zones, cushion-shaped packaging containers are created which, at their upper and lower ends, display sealing fins 3 which, after reforming of the packaging container into substantially parallelepipedic configuration, extend transversely over both end walls 2 of the packaging container. The sealing fins 3 have, in the packaging container illustrated in FIG. 1, been folded down throughout their entire length into abutment against one of the subjacent material surfaces (the end wall 2), with which they are connected.

In the forming processing which is required to reform the cushion-shaped packaging container into the illustrated, parallelepipedic configuration, four substantially triangular, double-walled corner flaps 4 are further created (of which only the two corner flaps located at the bottom wall of the packaging container are shown in the Figure). The corner flaps are folded over around the straight wall edges 8 along which they are connected to the parallelepipedic part proper of the packaging container and are fixed by means of thermosealing to the end wall of the packaging container. For the sake of clarity, only the one corner flap is shown in FIG. 1 in its final, downwardly folded position. The corner flap located at the opposite end of the end wall 2 is shown in a partly folded state, it being clearly apparent how the sealing fin 3 extending over the end wall 2 extends out over the one side of the corner flap 4 in order to terminate at the free corner of the corner of the corner flap facing away from the end wall 2.

FIG. 1 also shows a part of a longitudinal joint 5 which occurs on sealing of the longitudinal edges of the material web after reforming of the material web into tube form. The longitudinal joint 5 extends over the one side wall 1 of the packaging container and over parts of adjacent end walls 2, where the longitudinal joint 5 crosses a foot line 6 (which defines the sealing fin 3 from the end wall 2) and is terminated at the free edge line 7 of the sealing fin 3.

As was mentioned previously, the sealing fin 3 extending over the bottom wall 2 of the packaging container consists of parts of the material layers forming the packaging container which have been laid together against one another and sealed to one another inside-to-inside by thermosealing. The thus created sealing fin 3 must, so as not to constitute an obstacle, be folded in against a subjacent material layer, as shown in FIG. 1. In the subsequent inward folding of the corner flaps 4, not only the material layers forming the corner flaps will be folded, but also the part of the sealing fin 3 running out over the corner flap. Thus, the double-folded sealing fin 3 located under the inwardly folded corner flaps entails that the portion of the packaging material which is folded 180° along the edge line 8 will have a total thickness which is three times greater than the actual material thickness. As has already been mentioned, this naturally impedes the actual folding operation, but moreover entails that the material layers in the transitional region between this thickened portion and adjacent portions of normal thickness, i.e. substantially in the point of intersection between the foot line 6 and the edge line 8 will be subjected to powerful stresses. These stresses occur particularly in the material layers which, on the folding operation, will lie outside the neutral folding plane, and these material layers are, in such instance, exposed to a tensile stress which often not only deforms the material but also stretches the material layers beyond their ultimate breaking point, which entails that cracks occur. As was mentioned earlier, this is particularly critical when the packaging laminate 9 (FIG. 4) also includes, in addition to a central core or carrier layer 10 of fibre material and external layers 11, 12 of thermoplastic material, a layer 13 of aluminium foil located on one side of the carrier layer 10, since the stretch properties of the aluminium foil are considerably poorer than the stretch properties of the thermoplastic layers 11, 12.

FIGS. 2 and 3 illustrate, on a larger scale, the area 14 marked by ghosted lines of the end wall 2 of the packaging container illustrated in FIG. 1, it being clearly apparent how (FIG. 2) the sealing fin 3 is first folded down into abutment against the end wall 2 along the foot line 6, whereafter the downwardly folded sealing fin, together with the pertinent corner flap, is folded 180° along the incipient wall edge line 8. In FIG. 3, the arrow 15 shows the particularly critical region in which the two folds intersect or meet one another. Within this region, the material stresses are particularly high and the risk of crack formation is thereby at its greatest.

With a view, according to the present invention, to reducing the material stresses occurring on double-folding of the material, particularly within the critical region marked by the arrow 15, the material is subjected to heating in connection with the folding operation. Preferably, the paper layer of the material is here heated to a temperature of 80-250° C. in the fold region, which, for example, may be put into effect in that a hot air nozzle 16 is directed at the fold region and, for up to approx. 1 second, subjects the fold region to a concentrated air jet at a temperature of approx. 300° C., which is schematically illustrated in FIG. 1. The heating may be put into effect before the folding operation or during an ongoing folding cycle, for example once the sealing fin 3 has been partly folded down against an adjacent surface of the end wall 2 and, for example, makes an angle of approx. 45° with the above-mentioned end wall, which makes it possible further to concentrate the heating, since the end wall 2, together with the partly downwardly folded sealing fin “guides” and concentrates the heating to the desired region adjacent the foot line 6 where this intersects the wall edge line 8, i.e. in the region of the two mutually intersecting or meeting fold lines 6 and 8. The concentrated heating of the relevant fold region naturally entails that both the paper and the plastic layers are heated, but the essential factor is that the paper layer be heated to the glass-transition temperature (Tg) of the fibre material. The glass-transition temperature (or ‘glass point’) for fibre material varies with the moisture content of the material, but in general, for example, lignin has a glass-transition temperature of 72-128° C., hemicellulose 54-167° C. and paper pulp approx. 240° C. Practical experiments have shown that, on heating to a temperature between approx. 80 and 250° C. in the fold region, the fibre material becomes manifestly softer and thereby tougher, which, on the one hand, facilitates folding without the fibre material buckling or breaking in such a manner that adjacent layers of thermoplastic and aluminium foil are subjected to elevated stresses. Since all polymers which are employed in packaging laminates also soften at elevated temperatures, the laminate as a whole will be more pliable and easier to fold without excessive stresses occurring. An additional effect of the heating is that the sealing or bonding between the layers included in the material is reduced somewhat, which permits a certain “sliding” between the layers, a factor which further reduces and distributes the occurring stresses so that the risk of crack formation is reduced.

The disclosed temperature range for carrying out the method according to the present invention relates to the average temperature in the material within the relevant fold region, i.e. substantially the region in FIG. 3 marked by the arrow 15. The lower limit, 80° C., of the temperature range has been selected because, at temperatures below this point, no manifest, positive action on the material can be noted. At temperatures above 80° C., a gradually increasing softening of the thermoplastic layers included in the packaging laminate takes place, which per se renders the material more pliable and easier to fold, at the same time as the substantially centrally located fibre layer 10 progressively reaches the glass-transition temperature regions of the included fibre types and thereby passes from a more rigid, brittle state to a softer and more flexible state which affords improved bending properties and, as a result, lower stresses in connection with subsequent folding. The packaging material will hereby be softer as a whole and thereby reduce the loading and risk of the occurrence of cracks which are harmful to the tightness of the finished packaging container.

Within the temperature range, it is also possible to observe a certain “loosening” of the material, i.e. the bond between both the individual cellulose fibres included in the fibre material and between the cellulose fibres and adjacent layers of thermoplastic material is weakened somewhat, which is also positive from the point of view of folding. When the upper limits (250° C.) disclosed for the temperature range are approached, the positive effects are reduced somewhat at the same time as the outside of the material is, in connection with the heating, negatively affected. More precisely, that area of the fold region which is directly exposed to the hot airjet from the nozzle 16 will be discoloured, since the fibre layer is subjected to such elevated temperature that it assumes a yellow or brown tinge. The layer 11 of thermoplastic material located outside the fibre layer will also be damaged (burnt or molten) at temperatures above the upper temperature limit, or on heating for a longer period of time than approx. 1 second. Since, however, the desired effect is also achieved at temperatures below the upper limit, this has not, in practice, proved to be any major disadvantage, particularly not since the “burnt” region will, on finishing of the package, be concealed by the corner flap 4 downwardly folded against the end wall 2 of the packaging container and will thus be invisible to the consumer.

The requisite heating may also be provided with the aid of other sources of heat than hot air. For instance, tests have demonstrated that infra red heat (IR radiation), laser or dielectric heating may be employed with good results. Other heating methods or combinations of heating methods are also conceivable, and the final choice of source of heat is dependent upon the essential parameters which are relevant in each individual case, e.g. material types, time consumption, design of heating point (accessibility), etc.

As was previously mentioned, the method according to the present invention may be put into practice as a natural part of the normal manufacturing process for packaging containers of known type. Since the heating takes place in the final phase of the packaging manufacture, i.e. slightly before or during the inward folding of the corner flaps, the critical production, filling and sealing of the individual packaging containers will not be affected, but the equipment for reducing the method according to the present invention into practice may simply be mounted at that part of the filling machine where the so-called final folding of the packaging container takes place, i.e. the final forming from cushion shape into parallelepipedic configuration. Trials hitherto carried out have demonstrated that the method achieves good effect, and it has proved in practice possible to wholly reduce harmful crack formation in packaging containers which have been manufactured in a conventional manner but subjected to a heating in accordance with the method according to the present invention. The method according to the present invention has also proved to have good effect on the manufacture of packaging containers from packaging laminates that have intentionally been stored under conditions less suitable for the material in question which have therefore reached a moisture content that normally would unerringly entail serious crack formation on reforming into packaging containers.

What is claimed is:

1. A method of reducing material stresses on the double-folding of laminated paper/plastic material, characterised in that the paper layer (10) of the material (9) is heated to a temperature of 80-250° C. in the fold region.

2. The method as claimed in claim 1, characterised in that the heating takes place before the folding.

3. The method as claimed in claim 1, characterised in that the heating takes place during an ongoing folding cycle.

4. The method as claimed in claim 3, characterised in that the heating takes place in the region of two mutually intersecting or meeting fold lines (6, 8).

5. The method as claimed in claim 4, characterised in that the heating takes place prior to the folding along the second fold line (8).

6. The method as claimed in one or more of the preceding claims, characterised in that both the paper- (10) and the plastic layer (11, 12) are heated.

7. The method as claimed in one or more of the preceding claims, characterised in that the paper layer (10) is heated to the glass-transformation temperature of the fibre material.

8. The method as claimed in one or more of the preceding claims, characterised in that the heating takes place during a limited period of time, a maximum of approx. 1 second.

9. The method as claimed in one or more of the preceding claims, characterised in that the heating takes place by means of hot air.

10. The method as claimed in claim 9, characterised in that the hot air is supplied in the form of a concentrated flow which is directed against the outside of the packaging material (9).
